(19) United States
(12) Patent Application Publication
(10) Pub. No.: US 2023/0074112 A1
(43) Pub. Date: Mar. 9, 2023

(54) POLYMERIC GEL ELECTROLYTE SYSTEMS FOR HIGH-POWER SOLID-STATE BATTERY

(71) Applicant: GM GLOBAL TECHNOLOGY OPERATIONS LLC, Detroit, MI (US)

(72) Inventors: Qili SU, Shanghai (CN); Zhe LI, Shanghai (CN); Yong LU, Shanghai (CN); Haijing LIU, Shanghai (CN)

(73) Assignee: GM GLOBAL TECHNOLOGY OPERATIONS LLC, Detroit, MI (US)

(21) Appl. No.: 17/710,213

(22) Filed: Mar. 31, 2022

(30) Foreign Application Priority Data
Sep. 8, 2021 (CN) 202111049241.1

(51) Int. Cl. H01M 10/0565; H01M 10/0525

(52) U.S. Cl. CPC H01M 10/0565; H01M 10/0525; H01M 2300/0082; H01M 2300/0085

(57) ABSTRACT

The present disclosure provides a polymeric gel electrolyte for an electrochemical cell that cycles lithium ions. The polymeric gel electrolyte includes greater than or equal to about 0.1 wt. % to less than or equal to about 10 wt. % of a non-lithium salt. The non-lithium salt includes a non-lithium cation having an ion radius that is greater than or equal to about 80% to less than or equal to about 250% of an ion radius of a lithium ion. The polymeric gel electrolyte further includes greater than or equal to about 50 wt. % to less than or equal to about 99.9 wt. % of a non-volatile gel. The non-volatile gel includes greater than or equal to 0 wt. % to less than or equal to about 50 wt. % of a polymeric host and greater than or equal to about 5 wt. % to less than or equal to about 100 wt. % of a liquid electrolyte.

### CROSS-REFERENCE TO RELATED APPLICATIONS

This application claims the benefit and priority of Chinese Patent Application No. 202111049241.1 filed Sep. 8, 2021. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In instances of solid-state batteries, which include a solid-state electrolyte layer disposed between the solid-state electrodes, the solid-state electrolyte physically separates the solid-state electrodes so that a distinct separator is not required.

Semi-solid and solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, semi-solid electrolytes and/or solid-state electrolytes are generally non-volatile and non-flammable, so as to allow cells to be cycled under harsher conditions without experiencing diminished potential or thermal runaway, which can potentially occur with the use of liquid electrolytes. However, solid-state batteries often experience comparatively low power capabilities. Low power capabilities may be a result of interfacial resistance within the solid-state electrodes and/or at the electrode, and a solid-state electrolyte layer interfacial resistance caused by limited contact, or void spaces, between the solid-state active particles and/or the solid-state electrolyte particles. Accordingly, it would be desirable to develop high-performance solid-state and/or semi-solid battery designs, materials, and methods that improve power capabilities, as well as energy density.

### SUMMARY

This section provides a general summary of the disclosure, and is not a comprehensive disclosure of its full scope or all of its features.

The present disclosure relates to solid-state batteries, for example to bipolar solid-state batteries, including a polymeric gel electrolyte system and exhibiting enhanced interfacial contact (both micro and macro), and to methods for forming the same.

In various aspects, the present disclosure provides a polymeric gel electrolyte for an electrochemical cell that cycles lithium ions. The polymeric gel electrolyte may include greater than or equal to about 0.1 wt. % to less than or equal to about 10 wt. % of a non-lithium salt.

In one aspect, the non-lithium salt may include a non-lithium cation having an ion radius that is greater than or equal to about 80% to less than or equal to about 250% of an ion radius of a lithium ion.

In one aspect, the non-lithium cation may be selected from the group consisting of: sodium (Na⁺), calcium (Ca²⁺), magnesium (Mg²⁺), potassium (K⁺), aluminum (Al³⁺), iron (Fe²⁺), manganese (Mn²⁺), strontium (Sr²⁺), zinc (Zn²⁺), and combinations thereof.

In one aspect, the non-lithium salt may include an anion selected from the group consisting of: bis-trifluoromethanesulfonimide (TFSI⁻), bis(fluorosulfonyl)imide (FSI⁻), bis(pentafluoroethanesulfonyl)imide (BETI⁻), trifluoromethyl sulfonate (OTf⁻), tetrafluoroborate (BF⁴⁻), hexafluorophosphate(PF₆⁻), nitrate (NO₃⁻), chloride (Cl⁻), bromide (Br⁻), and combinations thereof.

In one aspect, the non-lithium salt may be selected from the group consisting of: magnesium bis(trifluoromethanesulfonyl)imide (Mg(TFSI)₂), calcium bis(trifluoromethanesulfonyl)imide (Ca(TFSI)₂), potassium bis(trifluoromethanesulfonyl)imide (KTFSI), sodium nitrate (NaNO₃), sodium hexafluorophosphate(NaPF₆), and combinations thereof.

In one aspect, the polymeric gel electrolyte system may further include greater than or equal to about 50 wt. % to less than or equal to about 99.9 wt. % of a non-volatile gel. The non-volatile gel may include a liquid electrolyte.

In one aspect, the non-volatile gel may further include a polymeric host. For example, the non-volatile gel may include greater than 0 wt. % to less than or equal to about 50 wt. % of the polymeric host, and greater than or equal to about 5 wt. % to less than or equal to about 99.9 wt. % of the liquid electrolyte.

In one aspect, the polymeric host may be selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

In one aspect, the liquid electrolyte may include a lithium salt and a solvent. The lithium salt may be selected from the group consisting of: lithium bis(fluorosulfonyl)imide (LiFSI), lithium bis(trifluoromethanesulfonyl)imide (LiTFSI), lithium bis(pentafluoroethanesulfonyl)imide (LiBETI), lithium hexafluorophosphate (LiPF₆), lithium tetrafluoroborate (LiBF₄), lithium trifluoromethyl sulfonate (LiTFO), lithium difluoro(oxalato)borate (LiDFOB), and combinations thereof. The solvent may be selected from the group consisting of: ethylene carbonate (EC), propylene carbonate (PC), gamma-butyrolactone (GBL), tetraethyl phosphate (TEP), fluoroethylene carbonate (FEC), and combinations thereof.

In one aspect, the non-volatile gel may further include greater than 0 wt. % to less than or equal to about 10 wt. % of an additive. The additive may be selected from the group consisting of: vinylene carbonate (VC), fluoroethylene carbonate (FEC), vinylethylene carbonate (VEC), butylene carbonate (BC), ethylene sulfite (ES), propylene sulfite (PS), and combinations thereof.

In various aspects, the present disclosure provides an electrochemical cell that cycles lithium ions. The electrochemical cell may include a first electrode, a second electrode, and an electrolyte layer disposed between the first electrode and the second electrode. The first electrode may include a first solid-state electroactive material. The second electrode may include a second solid-state electroactive material. At least one of the first electrode, the second electrode, and the electrolyte layer may include a polymeric gel electrolyte. The polymeric gel electrolyte may include greater than or equal to about 0.1 wt. % to less than or equal to about 10 wt. % of a non-lithium salt.

In one aspect, the electrolyte layer may include a plurality of solid-state electrolyte particles and the polymeric gel electrolyte system may at least partially fill void spaces between the solid-state electrolyte particles.

In one aspect, the electrolyte layer may include a free-standing membrane defined by the polymeric gel electrolyte system. The free-standing membrane may have a thickness greater than or equal to about 5 μm to less than or equal to about 1,000 μm.

In one aspect, the second solid-state electroactive material may be a two-dimensional electroactive material.

In one aspect, the polymeric gel electrolyte system may include a first polymeric gel electrolyte that at least partially fills void spaces in the first solid-state electroactive material, and a second polymeric gel electrolyte that at least partially fills void spaces in the second solid-state electroactive material.

In one aspect, the non-lithium salt may include a non-lithium cation having an ion radius that is greater than or equal to about 80% to less than or equal to about 250% of an ion radius of a lithium ion.

In one aspect, the non-lithium cation may be selected from the group consisting of: sodium (Na⁺), calcium (Ca²⁺), magnesium (Mg²⁺), potassium (K⁺), aluminum (Al³⁺), iron (Fe²⁺), manganese (Mn²⁺), strontium (S²⁺), zinc (Zn²⁺), and combinations thereof.

In one aspect, the polymeric gel electrolyte system may further include greater than or equal to about 50 wt. % to less than or equal to about 99.9 wt. % of a non-volatile gel. The non-volatile gel may include greater than or equal to 0 wt. % to less than or equal to about 50 wt. % of a polymeric host, and greater than or equal to about 5 wt. % to less than or equal to about 100 wt. % of a liquid electrolyte.

In one aspect, the non-volatile gel may further include greater than 0 wt. % to less than or equal to about 10 wt. % of an additive. The additive may be selected from the group consisting of: vinylene carbonate (VC), fluoroethylene carbonate (FEC), vinylethylene carbonate (VEC), butylene carbonate (BC), ethylene sulfite (ES), propylene sulfite (PS), and combinations thereof.

In various aspects, the present disclosure provides an electrochemical cell that cycles lithium ions. The electrochemical cell may include a first electrode, a second electrode, and an electrolyte layer disposed between the first electrode and the second electrode. The first electrode may include a first solid-state electroactive material. The second electrode may include a second solid-state electroactive material. At least one of the first electrode, the second electrode, and the electrolyte layer may include a polymeric gel electrolyte system. The polymeric gel electrolyte system may include greater than or equal to about 0.1 wt. % to less than or equal to about 10 wt. % of a non-lithium salt and greater than or equal to about 50 wt. % to less than or equal to about 99.9 wt. % of a non-volatile gel. The non-lithium salt may include a non-lithium cation selected from the group consisting of: sodium (Na⁺), calcium (Ca²⁺), magnesium (Mg²⁺), potassium (K⁺), aluminum (Al³⁺), iron (Fe²⁺), manganese (Mn²⁺), strontium (Sr²⁺), zinc (Zn²⁺), and combinations thereof. The non-volatile gel may include greater than or equal to 0 wt. % to less than or equal to about 50 wt. % of a polymeric host, and greater than or equal to about 5 wt. % to less than or equal to about 100 wt. % of a liquid electrolyte.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is an illustration of an example solid-state battery in accordance with various aspects of the present disclosure;

FIG. 1B is an example solid-state battery having a polymeric gel electrolyte system in accordance with various aspects of the present disclosure;

FIG. 1C is a schematic illustration of a two-dimensional electroactive material (e.g., graphite) in contact with a polymeric gel electrolyte system;

FIG. 2 is another example solid-state battery having a polymeric gel electrolyte system in accordance with various aspects of the present disclosure;

FIG. 3A is a graphical illustration demonstrating rate capability of example battery cells prepared in accordance with various aspects of the present disclosure; and

FIG. 3B is a graphical illustration demonstrating discharge curves for example battery cells prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs), for example only, bipolar solid-state batteries, and methods of forming and using the same. Solid-state batteries may include at least one solid component, for example, at least one solid electrode, but may also include semi-solid or gel, liquid, or gas components, in certain variations. Solid-state batteries may have a bipolar stack design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of the current collector that is substantially parallel with the first side. The first mixture may include, as the solid-state electroactive material particles, positive electrode or cathode material particles. The second mixture may include, as solid-state electroactive material particles, negative electrode or anode material particles. A series or stack of the bipolar electrodes forming the exemplary solid-state batteries may be physically separated by a separator and/or a solid-state electrolyte comprising solid-state electrolyte particles. The solid-state electrolyte particles in each instance may be the same or different.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

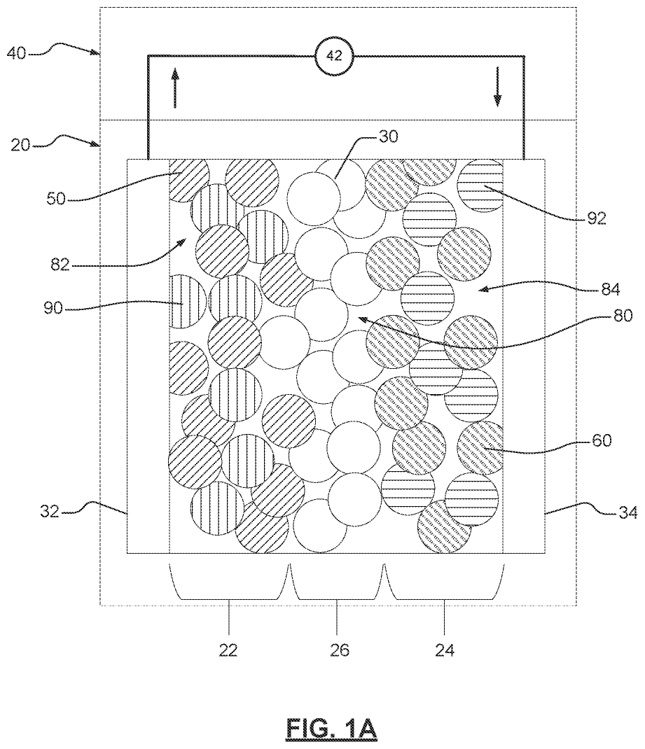

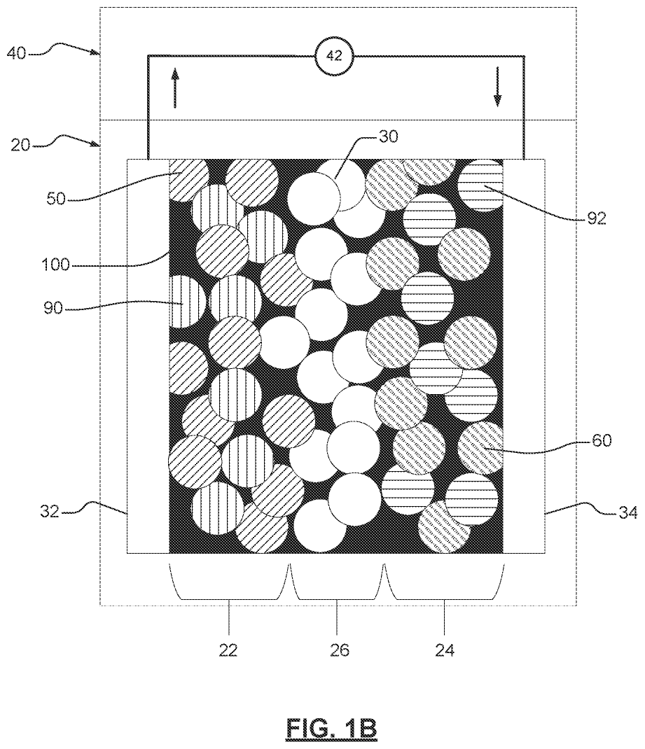

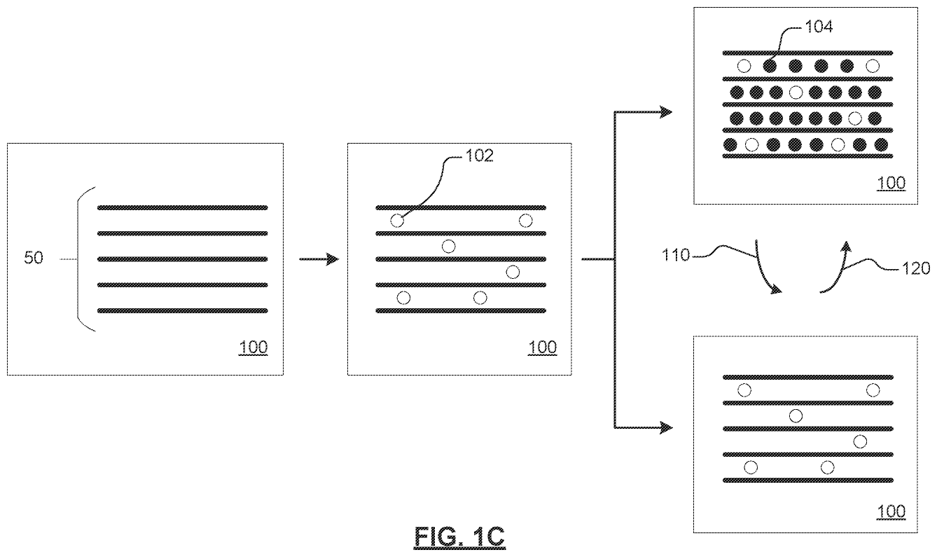

An exemplary and schematic illustration of a solid-state electrochemical cell unit (also referred to as a “solid-state battery” and/or “battery”) 20 that cycles lithium ions is shown in FIGS. 1A and 1B. The battery 20 includes a negative electrode (i.e., anode) 22, a positive electrode (i.e., cathode) 24, and an electrolyte layer 26 that occupies a space between the two or more electrodes. The electrolyte layer 26 may be a solid-state or semi-solid state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network.

A first bipolar current collector 32 may be positioned at or near the negative electrode 22. A second bipolar current collector 34 may be positioned at or near the positive electrode 24. The first and second bipolar current collectors 32, 34 may be the same or different. For example, the first and second bipolar current collectors 32, 34 may each have a thickness greater than or equal to about 2 μm to less than or equal to about 30 μm. The first and second bipolar current collectors 32, 34 may each have a thickness greater than or equal to 2 μm to less than or equal to 30 μm. The first and second bipolar current collectors 32, 34 may each be metal foils including at least one of stainless steel, aluminum, nickel, iron, titanium, copper, tin, alloys thereof, or any other electrically conductive material known to those of skill in the art.

In certain variations, the first bipolar current collector 34 and/or the second bipolar current collector 34 may be a cladded foil, for example, where one side (e.g., the first side or the second side) of the current collector 32, 34 includes one metal (e.g., first metal) and another side (e.g., the other side of the first side or the second side) of the current collector 232 includes another metal (e.g., second metal). The cladded foil may include, for example only, aluminum-copper (Al—Cu), nickel-copper (Ni—Cu), stainless steel-copper (SS-Cu), aluminum-nickel (Al—Ni), aluminum-stainless steel (Al-SS), and nickel-stainless steel (Ni-SS). In certain variations, the first bipolar current collector 232A and/or second bipolar current collectors 232B may be pre-coated, such as graphene or carbon-coated aluminum current collectors.

In each instance, the first bipolar current collector 32 and the second bipolar current collector 34 respectively collect and move free electrons to and from an external circuit 40 (as shown by the block arrows). For example, an interruptible external circuit 40 and a load device 42 may connect the negative electrode 22 (through the first bipolar current collector 32) and the positive electrode 24 (through the second bipolar current collector 34).

The battery 20 can generate an electric current (indicated by arrows in FIGS. 1A and 1B) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 toward the positive electrode 24. Lithium ions, which are also produced at the negative electrode 22, are concurrently transferred through the electrolyte layer 26 toward the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back toward the negative electrode 22 through the external circuit 40, and the lithium ions, which move across the electrolyte layer 26 back toward the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte layer 26.

In many configurations, each of the negative electrode current collector 32, the negative electrode 22, the electrolyte layer 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIGS. 1A and 1B, the electrolyte layer 26, which may be a semi-solid, provides electrical separation—preventing physical contact—between the negative electrode 22 and the positive electrode 24. The electrolyte layer 26 also provides a minimal resistance path for internal passage of ions. In various aspects, the electrolyte layer 26 may be defined by a first plurality of solid-state electrolyte particles 30. For example, the electrolyte layer 26 may be in the form of a layer or a composite that comprises the first plurality of solid-state electrolyte particles 30.

The solid-state electrolyte particles 30 may have an average particle diameter greater than or equal to about 0.02 μm to less than or equal to about 20 urn, optionally greater than or equal to about 0.1 μm to less than or equal to about 10 urn, and in certain aspects, optionally greater than or equal to about 0.1 μm to less than or equal to about 1 μm. The electrolyte layer 26 may be in the form of a layer having a thickness greater than or equal to about 1 μm to less than or equal to about 1,000 μm, optionally greater than or equal to about 5 μm to less than or equal to about 200 μm, optionally greater than or equal to about 10 μm to less than or equal to about 100 μm, optionally about 40 μm, and in certain aspects, optionally about 30 μm. The electrolyte layer 26 may have an interparticle porosity 80 between the solid-state electrolyte particles 30 that is greater than 0 vol. % to less than or equal to about 50 vol. %, optionally greater than or equal to about 1 vol. % to less than or equal to about 40 vol. %, and in certain aspects, optionally greater than or equal to about 2 vol. % to less than or equal to about 20 vol. %.

The solid-state electrolyte particles 30 may have an average particle diameter greater than or equal to 0.02 μm to less than or equal to 20 μm, optionally greater than or equal to 0.1 μm to less than or equal to 10 μm, and in certain aspects, optionally greater than or equal to 0.1 μm to less than or equal to 1 μm. The electrolyte layer 26 may be in the form of a layer having a thickness greater than or equal to 1 μm to less than or equal to 1,000 μm, optionally greater than or equal to 5 μm to less than or equal to 200 μm, optionally greater than or equal to 10 μm to less than or equal to 100 μm, optionally 40 μm, and in certain aspects, optionally 30 μm. The electrolyte layer 26 may have an interparticle porosity 80 between the solid-state electrolyte particles 30 that is greater than 0 vol. % to less than or equal to 50 vol. %, optionally greater than or equal to 1 vol. % to less than or equal to 40 vol. %, and in certain aspects, optionally greater than or equal to 2 vol. % to less than or equal to 20 vol. %.

The solid-state electrolyte particles 30 may comprise one or more sulfide-based particles, oxide-based particles, metal-doped or aliovalent-substituted oxide particles, inactive oxide particles, nitride-based particles, hydride-based particles, halide-based particles, and borate-based particles.

In certain variations, the sulfide-based particles may include, for example only, a pseudobinary sulfide, a pseudoternary sulfide, and/or a pseudoquaternary sulfide. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂Si₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI.0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ (PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.709}, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the inactive oxide particles may include, for example only, SiO₂, Al₂O₃, TiO₂, ZrO₂, and combinations thereof; the nitride-based particles may include, for example only, Li₃N, Li₇PN₄, LiSi₂N₃, and combinations thereof; the hydride-based particles may include, for example only, LiBH₄, LiBH₄—LiX (where X=Cl, Br, or I), LiNH₂, Li₂NH, LiBH₄—LiNH₂, Li₃AlH₆, and combinations thereof; the halide-based particles may include, for example only, LiI, Li₃InCl₆, Li₂CdCl₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O—B₂O₃—P₂O₅, and combinations thereof.

In various aspects, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), Li_{3.4}Si_{0.4}P_{0.6}S₄, PL₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), LiMM′(PO₄)₃ (where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), LiI—Li₄SnS₄, Li₄SnS₄, Li₃N, Li₇PN₄, LiSi₂N₃, LiBH₄, LiBH₄—LiX (where x=Cl, Br, or I), LiNH₂, Li₂NH, LiBH₄—LiNH₂, Li₃AlH₆, LiI, Li₃InCl₆, Li₂CdCi₄, Li₂MgCl₄, LiCdI₄, Li₂ZnI₄, Li₃OCl, Li₂B₄O₇, Li₂O—B₂O₃—P₂O₅, and combinations thereof.

In certain variations, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀S₁₁P₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, and combinations thereof.

Although not illustrated, the skilled artisan will recognize that in certain instances, one or more binder particles may be mixed with the solid-state electrolyte particles 30. For example, in certain aspects, the electrolyte layer 26 may include greater than or equal to 0 wt. % to less than or equal to about 10 wt. %, and in certain aspects, optionally greater than or equal to about 0.5 wt. % to less than or equal to about 10 wt. %, of the one or more binders. The electrolyte layer 26 may include greater than or equal to 0 wt. % to less than or equal to 10 wt. %, and in certain aspects, optionally greater than or equal to 0.5 wt. % to less than or equal to 10 wt. %, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

The negative electrode 22 may be formed from a lithium host material that is capable of functioning as a negative terminal of a lithium-ion battery. The negative electrode 22 may be in the form of a layer having a thickness greater than or equal to about 1 μm to less than or equal to about 1000 μm, optionally greater than or equal to about 5 μm to less than or equal to about 400 μm, and in certain aspects, optionally greater than or equal to about 10 μm to less than or equal to about 300 μm. The negative electrode 22 may be in the form of a layer having a thickness greater than or equal to 1 μm to less than or equal to 1000 μm, optionally greater than or equal to 5 μm to less than or equal to 400 μm, and in certain aspects, optionally greater than or equal to 10 μm to less than or equal to 300 μm. In certain variations, the negative electrode 22 may be defined by a plurality of the negative solid-state electroactive particles 50. The negative solid-state electroactive particles 50 may have an average particle diameter greater than or equal to about 0.01 μm to less than or equal to about 50 μm, and in certain aspects, optionally greater than or equal to about 1 μm to less than or equal to about 20 μm. The negative solid-state electroactive particles 50 may have an average particle diameter greater than or equal to 0.01 μm to less than or equal to 50 μm, and in certain aspects, optionally greater than or equal to 1 μm to less than or equal to 20 μm.

The second plurality of solid-state electrolyte particles 90 may be the same as or different from the first plurality of solid-state electrolyte particles 30. In certain variations, the negative solid-state electroactive particles 50 may comprise one or more carbonaceous negative electroactive materials, such as graphite, mesocarbon microbeads (MCMB), graphite carbon fiber, expanded graphite, soft carbon, hard carbon, nature graphite, graphene, carbon nanotubes (CNTs). In other variations, the negative solid-state electroactive particles 50 may be silicon-based comprising, for example, a silicon alloy and/or silicon-graphite mixture. The negative solid-state electroactive particles 50 may include a two-dimensional material, such as two-dimensional transition metal dichalcogenides (e.g., a layered MoS₂, which may have an interlayer thickness of about 0.62 nm) and/or a two-dimensional silicon.

In certain instances, as illustrated, the negative electrode 22 may be a composite comprising a mixture of the negative solid-state electroactive particles 50 and the second plurality of solid-state electrolyte particles 90. For example, the negative electrode 22 may include greater than or equal to about 30 wt. % to less than or equal to about 99.5 wt. %, and in certain aspects, optionally greater than or equal to about 50 wt. % to less than or equal to about 95 wt. %, of the negative solid-state electroactive particles 50, and greater than or equal to 0 wt. % to less than or equal to about 70 wt. %, optionally greater than or equal to 0 wt. % to less than or equal to about 50 wt. %, and in certain aspects, optionally greater than or equal to about 5 wt. % to less than or equal to about 20 wt. %, of the second plurality of solid-state electrolyte particles 90. The negative electrode 22 may include greater than or equal to 30 wt. % to less than or equal to 99.5 wt. %, and in certain aspects, optionally greater than or equal to 50 wt. % to less than or equal to 95 wt. %, of the negative solid-state electroactive particles 50, and greater than or equal to 0 wt. % to less than or equal to 70 wt. %, optionally greater than or equal to 0 wt. % to less than or equal to 50 wt. %, and in certain aspects, optionally greater than or equal to 5 wt. % to less than or equal to 20 wt. %, of the second plurality of solid-state electrolyte particles 90.

The second plurality of solid-state electrolyte particles 90 may be the same as or different from the first plurality of solid-state electrolyte particles 30 and/or the third plurality of solid-state electrolyte particles 92. The negative electrodes 22 may have an interparticle porosity 82 between the negative solid-state electroactive particles 50 and/or the solid-state electrolyte particles 90 that is greater than or equal to 0 vol. % to less than or equal to about 50 vol. %, and in certain aspects, optionally greater than or equal to about 2 vol. % to less than or equal to about 20 vol. %. The negative electrodes 22 may have an interparticle porosity 82 between the negative solid-state electroactive particles 50 and/or the solid-state electrolyte particles 90 that is greater than or equal to 0 vol. % to less than or equal to 50 vol. %, and in certain aspects, optionally greater than or equal to 2 vol. % to less than or equal to 20 vol. %.

Although not illustrated, in certain variations, the negative electrode 22 may include one or more conductive additives and/or binder materials. For example, the negative solid-state electroactive particles 50 (and/or optional second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90 (and/or optional second plurality of solid-state electrolyte particles 90) may be optionally intermingled with binders, such as polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as, KETCHEN™ black or DENKA™ black), carbon fibers and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders.

The negative electrode 22 may include greater than or equal to 0 wt. % to less than or equal to 30 wt. %, and in certain aspects, optionally greater than or equal to 2 wt. % to less than or equal to 10 wt. %, of the one or more electrically conductive additives; and greater than or equal to 0 wt. % to less than or equal to 20 wt. %, and in certain aspects, optionally greater than or equal to 1 wt. % to less than or equal to 10 wt. %, of the one or more binders.

The positive electrode 24 may be formed from a lithium-based or electroactive material that can undergo lithium intercalation and deintercalation while functioning as the positive terminal of the battery 20. The positive electrode 24 may be in the form of a layer having a thickness greater than or equal to about 1 μm to less than or equal to about 1,000 μm, optionally greater than or equal to about 5 μm to less than or equal to about 400 μm, and in certain aspects, optionally greater than or equal to about 10 μm to less than or equal to about 300 μm. The positive electrode 24 may be in the form of a layer having a thickness greater than or equal to 1 μm to less than or equal to 1,000 μm, optionally greater than or equal to 5 μm to less than or equal to 400 μm, and in certain aspects, optionally greater than or equal to 10 μm to less than or equal to 300 μm

In certain variations, the positive electrode 24 may be defined by a plurality of the positive solid-state electroactive particles 60. The positive solid-state electroactive particles 60 may have an average particle diameter greater than or equal to about 0.01 μm to less than or equal to about 50 μm, and in certain aspects, optionally greater than or equal to about 1 μm to less than or equal to about 20 μm. The positive solid-state electroactive particles 60 may have an average particle diameter greater than or equal to 0.01 μm to less than or equal to 50 μm, and in certain aspects, optionally greater than or equal to 1 μm to less than or equal to 20 μm.

In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x<1 and 0<y<1), LiNiₓMn₁₋ₓO₂ (where 0≤x≤1), and Li₁₊ₓMO₂(where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiMₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60, and greater than or equal to 0 wt. % to less than or equal to about 70 wt. %, optionally greater than or equal to 0 wt. % to less than or equal to about 50 wt. %, and in certain aspects, optionally greater than or equal to about 5 wt. % to less than or equal to about 20 wt. %, of the third plurality of solid-state electrolyte particles 92.

The positive electrode 24 may include greater than or equal to 30 wt. % to less than or equal to 98 wt. %, and in certain aspects, optionally greater than or equal to 50 wt. % to less than or equal to 95 wt. %, of the positive solid-state electroactive particles 60, and greater than or equal to 0 wt. % to less than or equal to 70 wt. %, optionally greater than or equal to 0 wt. % to less than or equal to 50 wt. %, and in certain aspects, optionally greater than or equal to 5 wt. % to less than or equal to 20 wt. %, of the third plurality of solid-state electrolyte particles 92.

The third plurality of solid-state electrolyte particles 92 may be the same as or different from the first and/or second pluralities of solid-state electrolyte particles 30, 90. The positive electrodes 24 may have an interparticle porosity 84 between the positive solid-state electroactive particles 60 and/or the solid-state electrolyte particles 92 that is greater than or equal to 0 vol. % to less than or equal to about 50 vol. %, and in certain aspects, optionally greater than or equal to about 2 vol. % to less than or equal to about 20 vol. %. The positive electrodes 24 may have an interparticle porosity 84 between the positive solid-state electroactive particles 60 and/or the solid-state electrolyte particles 92 that is greater than or equal to 0 vol. % to less than or equal to 50 vol. %, and in certain aspects, optionally greater than or equal to 2 vol. % to less than or equal to 20 vol. %.

Although not illustrated, in certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as, KETCHEN™ black or DENKA™ black), carbon fibers and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders.

The positive electrode 24 may include greater than or equal to 0 wt. % to less than or equal to 30 wt. %, and in certain aspects, optionally greater than or equal to 2 wt. % to less than or equal to 10 wt. %, of the one or more electrically conductive additives; and greater than or equal to 0 wt. % to less than or equal to 20 wt. %, and in certain aspects, optionally greater than or equal to 1 wt. % to less than or equal to 10 wt. %, of the one or more binders.

As illustrated in FIG. 1A, direct contact between the solid-state electroactive particles 50, 60 and/or the solid-state electrolyte particles 30, 90, 92 may be much lower than the contact between a liquid electrolyte and solid-state electroactive particles in comparable non-solid-state batteries. For example, as illustrated in FIG. 1A, a battery 20 in green form may have an overall interparticle porosity that is greater than or equal to about 10 vol. % to less than or equal to about 40 vol. %. A battery 20 in green form may have an overall interparticle porosity that is greater than or equal to 10 vol. % to less than or equal to 40 vol. %. In certain variations, a polymeric gel electrolyte (e.g., a semi-solid electrolyte) may be disposed within a solid-state battery so as to wet interfaces and/or fill void spaces between the solid-state electrolyte particles and/or the solid-state active material particles. However, such polymeric gel electrolytes often do not enable fast lithium-ion intercalation and deintercalation, particularly in the instance of graphite-containing negative electrodes.

The present disclosure provides a polymeric gel electrolyte system 100. A gel electrolyte system has a viscosity greater than or equal to about 10,000 centipoise. In various aspects, the polymeric gel system 100 includes non-lithium cations that enable pre-intercalation prior to lithiation, thereby improving power performance, for example at 10° C. For example, as illustrated in FIG. 1B, the polymeric gel electrolyte system 100 may be disposed within the battery 20 between the solid-state electrolyte particles 30, 90, 92 and/or the solid-state electroactive particles 50, 60, so as to, for example only, reduce interparticle porosity 80, 82, 84 and improve ionic contact and/or enable higher thermal stability. In certain variations, the battery 20 may include greater than or equal to about 0.5 wt. % to less than or equal to about 50 wt. %, and in certain aspects, optionally greater than or equal to about 5 wt. % to less than or equal to about 35 wt. %, of the polymeric gel electrolyte system 100. The battery 20 may include greater than or equal to 0.5 wt. % to less than or equal to 50 wt. %, and in certain aspects, optionally greater than or equal to 5 wt. % to less than or equal to 35 wt. %, of the polymeric gel electrolyte system 100.

Although it appears that there are no pores or voids remaining in the illustrated figure, some porosity may remain between adjacent particles (including, for example only, between the solid-state electroactive particles 50 and/or the solid-state electrolyte particles 90 and/or the solid-state electrolyte particles 30, and between the solid-state electroactive particles 60 and/or the solid-state electrolyte particles 92 and/or the solid-state electrolyte particles 30) depending on the penetration of the polymeric gel electrolyte system 100. For example, a battery 20 including the polymeric gel electrolyte system 100 may have a porosity less than or equal to about 50 vol. %, and in certain aspects, optionally less than or equal to about 30 vol. %. A battery 20 including the polymeric gel electrolyte system 100 may have a porosity less than or equal to 50 vol. %, and in certain aspects, optionally less than or equal to 30 vol. %. A battery 20 including the polymeric gel electrolyte system 100 may have a porosity less than or equal to about 50 vol. %, and in certain aspects, optionally less than or equal to about 30 vol. %. A battery 20 including the polymeric gel electrolyte system 100 may have a porosity less than or equal to 50 vol. %, and in certain aspects, optionally less than or equal to 30 vol. %.

In various aspects, the polymeric gel electrolyte system 100 includes a non-volatile gel and a non-lithium salt. For example, the polymeric gel electrolyte system 100 may include greater than or equal to about 50 wt. % to less than or equal to about 99.9 wt. %, and in certain aspects, optionally greater than or equal to about 80 wt. % to less than or equal to about 99.5 wt. %, of the non-volatile gel, and greater than or equal to about 0.1 wt. % to less than or equal to about 20 wt. %, and in certain aspects, optionally greater than or equal to about 0.5 wt. % to less than or equal to about 10 wt. %, of the non-lithium salt. The polymeric gel electrolyte system 100 may include greater than or equal to 50 wt. % to less than or equal to 99.9 wt. %, and in certain aspects, optionally greater than or equal to 80 wt. % to less than or equal to 99.5 wt. %, of the non-volatile gel, and greater than or equal to 0.1 wt. % to less than or equal to 20 wt. %, and in certain aspects, optionally greater than or equal to 0.5 wt. % to less than or equal to 10 wt. %, of the non-lithium salt.

A non-volatile is one having a low vapor pressure, for example, less than or equal to about 10 mmHg at 25° C. In various aspects, the non-volatile gel may include greater than or equal to 0 wt. % to less than or equal to about 50 wt. %, and in certain aspects, optionally, greater than or equal to about 1 wt. % to less than or equal to about 20 wt. %, of the polymeric host, and greater than or equal to about 5 wt. % to less than or equal to about 100 wt. %, and in certain aspects, optionally greater than or equal to about 80 wt. % to less than or equal to about 90 wt. %, of the liquid electrolyte. The non-volatile gel may include greater than or equal to 0 wt. % to less than or equal to 50 wt. %, and in certain aspects, optionally, greater than or equal to 1 wt. % to less than or equal to 20 wt. %, of the polymeric host, and greater than or equal to 5 wt. % to less than or equal to 100 wt. %, and in certain aspects, optionally greater than or equal to 80 wt. % to less than or equal to 90 wt. %, of the liquid electrolyte.

In certain variations, the non-volatile gel further includes an additive. For example, the non-volatile gel may include greater than or equal to 0 wt. % to less than or equal to about 20 wt. %, and in certain aspects, optionally, greater than or equal to about 0.1 wt. % to less than or equal to about 10 wt. %, of the additive. The non-volatile gel may include greater than or equal to 0 wt. % to less than or equal to 20 wt. %, and in certain aspects, optionally, greater than or equal to 0.1 wt. % to less than or equal to 10 wt. %, of the additive.

The polymeric host may be selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

The liquid electrolyte may include a lithium salt and a solvent. For example, the liquid electrolyte may include greater than or equal to about 5 wt. % to less than or equal to about 70 wt. %, and in certain aspects, optionally greater than or equal to about 10 wt. % to less than or equal to about 50 wt. %, of the lithium salt, and greater than or equal to about 30 wt. % to less than or equal to about 95 wt. %, and in certain aspects, optionally greater than or equal to about 50 wt. % to less than or equal to about 90 wt. %, of the solvent. The liquid electrolyte may include greater than or equal to 5 wt. % to less than or equal to 70 wt. %, and in certain aspects, optionally greater than or equal to 10 wt. % to less than or equal to 50 wt. %, of the lithium salt, and greater than or equal to 30 wt. % to less than or equal to 95 wt. %, and in certain aspects, optionally greater than or equal to 50 wt. % to less than or equal to 90 wt. %, of the solvent.

The lithium salt may include, for example, lithium hexafluoroarsenate (LiAsF₆), lithium hexafluorophosphate (LiPF₆), lithium bis(fluorosulfonyl)imide (LiFSI), lithium perchlorate (LiClO₄), lithium tetrafluoroborate (LiBF₄), lithium-cyclo-difluoromethane-1,1-bis(sulfonyl)imide (LiDMSI), lithium bis(trifluoromethanesulfonyl)imide (LiTFSI), lithium bis(pentafluoroethanesulfonyl)imide (LiBETI), lithium bis(oxalato)borate (LiBOB), lithium difluoro(oxalato)borate (LiDFOB), lithium bis(monofluoromalonato)borate (LiBFMB), lithium difluorophosphate (LiPO₂F₂), lithium fluoride (LiF), and combinations thereof. In certain variations, the lithium salt may be selected from the group consisting of: lithium bis(fluorosulfonyl)imide (LiFSI), lithium bis(trifluoromethanesulfonyl)imide (LiTFSI), lithium bis(pentafluoroethanesulfonyl)imide (LiBETI), lithium hexafluorophosphate (LiPF₆), lithium tetrafluoroborate (LiBF₄), lithium trifluoromethyl sulfonate (LiTFO), lithium difluoro(oxalato)borate (LiDFOB), and combinations thereof.

The solvent dissolves the lithium salt to enable good lithium ion conductivity, while exhibiting a low vapor pressure (e.g., less than about 10 mmHg at 25° C.) to match the cell fabrication process. In various aspects, the solvent includes, for example, carbonate solvents (such as, ethylene carbonate (EC), propylene carbonate (PC), glycerol carbonate, vinylene carbonate, fluoroethylene carbonate, 1,2-butylene carbonate, and the like), lactones (such as, γ-butyrolactone (GBL), δ-valerolactone, and the like), nitriles (such as, succinonitrile, glutaronitrile, adiponitrile, and the like), sulfones (such as, tetramethylene sulfone, ethyl methyl sulfone, vinyl sulfone, phenyl sulfone, 4-fluorophenyl sulfone, benzyl sulfone, and the like), ethers (such as, triethylene glycol dimethylether (triglyme, G3), tetraethylene glycol dimethylether (tetraglyme, G4), 1,3-dimethyoxy propane, 1,4-dioxane, and the like), phosphates (such as, triethyl phosphate, trimethyl phosphate, and the like), ionic liquids including ionic liquid cations (such as, 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and the like) and ionic liquid anions (such as, bis(trifluoromethanesulfonyl)imide (TFSI), bis(fluorosulfonyl imide (FS), and the like), and combinations thereof. For example, the solvent may be selected from the group consisting of: ethylene carbonate (EC), propylene carbonate (PC), gamma-butyrolactone (GBL), tetraethyl phosphate (TEP), fluoroethylene carbonate (FEC), and combinations thereof.

The additive may be selected to encourage formation of a robust and thin solid-electrolyte interface (SEI) layer on or adjacent to one or more surfaces of the negative electrode 22, for example on the surface of the negative electrode 22 opposing the electrolyte layer 26. In various aspects, the first additive may include, for example, unsaturated carbon bond containing compounds (such as, vinylene carbonate (VC), vinyl ethylene carbonate (VEC), and the like), sulfur-containing compounds (such as, ethylene sulfite (ES), propylene sulfite (PyS), and the like), halogen-containing compounds (such as, fluoroethylene carbonate (FEC), chloro-ethylene carbonate (Cl-EC), and the like), methyl substituted glycolide derivatives, maleimide (MI) additives, additives or compounds containing electron withdrawing groups, and combinations thereof. For example, the additive may be selected from the group consisting of: vinylene carbonate (VC), fluoroethylene carbonate (FEC), vinylethylene carbonate (VEC), butylene carbonate (BC), ethylene sulfite (ES), propylene sulfite (PS), and combinations thereof.

The non-lithium salt should be soluble in the solvent (e.g., ethylene carbonate (EC), propylene carbonate (PC), gamma-butyrolactone (GBL), tetraethyl phosphate (TEP), and/or fluoroethylene carbonate (FEC)) of the liquid electrolyte. The non-lithium salt includes a non-lithium cation and an anion. The non-lithium cation should have an ion radius that is comparable with or larger than the radius of a lithium ion (Lit).

For example, the non-lithium cation may have a ion radius that is greater than or equal to about 80% to less than or equal to about 250%, optionally greater than or equal to about 100% to less than or equal to about 250%, optionally greater than or equal to about 110% to less than or equal to about 250%, optionally greater than or equal to about 120% to less than or equal to about 250%, optionally greater than or equal to about 130% to less than or equal to about 250%, optionally greater than or equal to about 140% to less than or equal to about 250%, optionally greater than or equal to about 150% to less than or equal to about 250%, optionally greater than or equal to about 160% to less than or equal to about 250%, optionally greater than or equal to about 170% to less than or equal to about 250%, optionally greater than or equal to about 180% to less than or equal to about 250%, optionally greater than or equal to about 190% to less than or equal to about 250%, optionally greater than or equal to about 200% to less than or equal to about 250%, optionally greater than or equal to about 210% to less than or equal to about 250%, optionally greater than or equal to about 220% to less than or equal to about 250%, optionally greater than or equal to about 230% to less than or equal to about 250%, and in certain aspects, optionally greater than or equal to about 240% to less than or equal to about 250%, of a ion radius of a lithium ion.

The non-lithium cation may have a ion radius that is greater than or equal to 80% to less than or equal to 250%, optionally greater than or equal to 100% to less than or equal to 250%, optionally greater than or equal to 110% to less than or equal to 250%, optionally greater than or equal to 120% to less than or equal to 250%, optionally greater than or equal to 130% to less than or equal to 250%, optionally greater than or equal to 140% to less than or equal to 250%, optionally greater than or equal to 150% to less than or equal to 250%, optionally greater than or equal to 160% to less than or equal to 250%, optionally greater than or equal to 170% to less than or equal to 250%, optionally greater than or equal to 180% to less than or equal to 250%, optionally greater than or equal to 190% to less than or equal to 250%, optionally greater than or equal to 200% to less than or equal to 250%, optionally greater than or equal to 210% to less than or equal to 250%, optionally greater than or equal to 220% to less than or equal to 250%, optionally greater than or equal to 230% to less than or equal to 250%, and in certain aspects, optionally greater than or equal to 240% to less than or equal to 250%, of a ion radius of a lithium ion.

In certain variations, the non-lithium cation may be selected from the group consisting of: sodium (Na⁺), calcium (Ca²⁺), magnesium (Mg²⁺), potassium (K⁺), aluminum (Al³⁺), iron (Fe²⁺), manganese (Mn²⁺), strontium (Sr²⁺), zinc (Zn²⁺), and combinations thereof. A lithium ion (Lit) may have a radius (pm) of about 76. A magnesium ion (Mg²) may have a radius (pm) of about 72. A calcium ion (Ca²) may have a radius (pm) of about 100. A potassium ion (K⁺) may have a radius (pm) of about 138. A lithium ion (Lit) may have a radius (pm) of 76. A magnesium ion (Mg²⁺) may have a radius (pm) of 72. A calcium ion (Ca²) may have a radius (pm) of 100. A potassium ion (K⁺) may have a radius (pm) of 138.

The anion may be the same or different from the anion of the liquid electrolyte. For example, in certain variations, the anion may be selected from the group consisting of: bis-trifluoromethanesulfonimide (TFSI⁻), bis(fluorosulfonyl)imide (FSI⁻), bis(pentafluoroethanesulfonyl)imide (BETI⁻), trifluoromethyl sulfonate (OTf⁻), tetrafluoroborate (BF⁴⁻), hexafluorophosphate(PF₆⁻), nitrate (NO₃⁻), chloride(Cl⁻), bromide (Br⁻), and combinations thereof. Thus, the non-lithium salt may be selected from the group consisting of: magnesium bis(trifluoromethanesulfonyl)imide (Mg(TFSI)₂), calcium bis(trifluoromethanesulfonyl)imide (Ca(TFSI)₂), potassium bis(trifluoromethanesulfonyl)imide (KTFSI), sodium nitrate (NaNO₃), sodium hexafluorophosphate (NaPF₆), and combinations thereof.

In each variation, the non-lithium cation is selected to pre-intercalate into the electroactive material (e.g., graphite) of the negative electrode 22 prior to lithiation, such that the non-lithium cation can serve as a pillar to facilitate subsequent lithium transportation. The non-lithium cation may pre-intercalate into the electroactive material of the negative electrode 22 prior to lithiation as a result of chemical potential differentiation. That is, the electrochemical potential of the non-lithium cations intercalation into the electroactive material of the negative electrode 22 is higher than the electrochemical potential of lithium ions intercalation into the electroactive material of the negative electrode 22. In certain variations, the potential difference for the non-lithium cation and the lithium ions may be greater than or equal to about 0.1 V to less than or equal to about 3V. The potential difference for the non-lithium cation and the lithium ions may be greater than or equal to 0.1 V to less than or equal to 3V.

FIG. 1C is a schematic illustration of a two-dimensional electroactive material (e.g., graphite) 50 in contact with a polymeric gel electrolyte system 100. As illustrated, during battery 20 formation, non-lithium cations 102 from the polymeric gel electrolyte system 100 intercalates and expands layers of the two-dimensional electroactive material 50, and during subsequent charging 110 and discharging 120 events lithium ions 104 moves into and out of the electroactive material, in relation to the non-lithium cations. Intercalation of the non-lithium cations 102 may increases d-spacing, also referred to as interlayer spacing, of the two-dimensional electroactive material 50, so as to broaden the passageways for lithium ions, thereby improving lithium ion transportation.

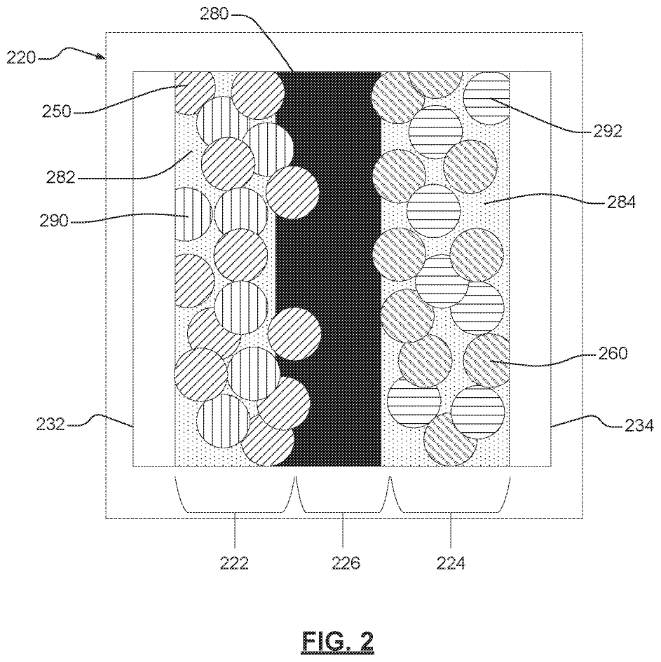

An exemplary and schematic illustration of another solid-state electrochemical cell unit 200 that cycles lithium ions is shown in FIG. 2. Like battery 20, the battery 220 includes a negative electrode (i.e., anode) 222, a first bipolar current collector 232 positioned at or near a first side of the negative electrode 222, a positive electrode (i.e., cathode) 224, a second bipolar current collector 234 positioned at or near a first side of the positive electrode 224, and an electrolyte layer 226 disposed between a second side of the negative electrode 222 and a second side of the positive electrode 224, where the second side of the negative electrode 222 is substantially parallel with the first side of the negative electrode 222 and the second side of the positive electrode 224 is substantially parallel with the first side of the positive electrode 224.

Like the negative electrode 22 illustrated in FIGS. 1A and 1B, the negative electrode 222 may include a plurality of negative solid-state electroactive particles 250 mixed with an optional first plurality of solid-state electrolyte particles 290. The negative electrode 222 may further include a first polymeric gel electrolyte system 282 that at least partially fills void spaces between the negative solid-state electroactive particles 250 and/or the optional solid-state electrolyte particles 290.

Like the positive electrode 24 illustrated in FIGS. 1A and 1B, the positive electrode 224 may include a plurality of positive solid-state electroactive particles 260 mixed with an optional second plurality of solid-state electrolyte particles 292. The positive electrode 224 may further include a second polymeric gel system 284 that at least partially fills void spaces between the positive solid-state electroactive particles 260 and/or the optional solid-state electrolyte particles 292. The second polymeric gel system 284 may be the same or different from the first polymeric gel system 282. Like the polymeric gel electrolyte system illustrated in FIGS. 1A and 1B, the first and second polymeric gel systems 282, 284 illustrated in FIG. 2 include a non-volatile gel and a non-lithium salt.

The electrolyte layer 226 may be a separating layer that physically separates the negative electrode 222 from the positive electrode 224. The electrolyte layer 226 may be a free-standing membrane 280 defined by a third polymeric gel electrolyte system comprising a non-volatile gel and a non-lithium salt similar to the polymeric gel electrolyte system illustrated in FIGS. 1A and 1B. In certain variations, the free-standing membrane 280 may have a thickness greater than or equal to about 5 μm to less than or equal to about 1,000 μm, and in certain aspects, optionally greater than or equal to about 2 μm to less than or equal to about 100 μm. The free-standing membrane 280 may have a thickness greater than or equal to 5 μm to less than or equal to 1,000 μm, and in certain aspects, optionally greater than or equal to 2 μm to less than or equal to 100 μm.

Although not illustrated, the skilled artisan will recognize that, in certain variations, the negative electrode 222 may be free of a first polymeric gel electrolyte system 282 and/or the positive electrode 224 may be free of a second polymeric gel electrolyte system 284. Similarly, considering the teachings of FIGS. 1A and 1B, although not illustrated, the skilled artisan will recognize that, in certain variations, the negative electrode 22, the positive electrode 24, and/or the electrolyte layer 26 may be free of the polymeric gel electrolyte system 100. That is, in the instance of FIG. 1B, one of the negative electrode 22, the positive electrode 24, and/or the electrolyte layer 26 may include polymeric gel electrolyte system 100.

In various aspects, the present disclosure provides methods for fabricating a battery including a gel electrolyte system, such as the battery 20 illustrated in FIG. 1B and/or the battery 200 illustrated in FIG. 2.

For example, in certain variations, the present disclosure contemplates a method of making a first electrode, where the method generally includes contacting a first precursor liquid with a first or negative electrode precursor in the form of a first or negative electroactive material layer, and concurrently or simultaneously, contacting a second precursor liquid with a second or positive electrode precursor in the form of a second or positive electroactive material layer. The first precursor liquid may be the same as or different from the second precursor liquid. In such instances, the method further includes drying or reacting (e.g., cross-linking) the first precursor liquid to form a gel-assisted first or negative electrode that includes a first polymeric gel electrolyte, and concurrently or simultaneously, drying or reacting (e.g., cross-linking) the second precursor liquid to form a gel-assisted second or positive electrode that includes a second polymeric gel electrolyte

The method may also include, concurrently or simultaneously with the first and/or second contacts, contacting a third precursor liquid with a precursor electrolyte layer including a plurality of solid-state electrolyte particles and drying or reacting (e.g., cross-linking) the third precursor liquid to form a gel-assisted electrolyte layer including a third polymeric gel electrolyte. In other variations, the method may further include, concurrently or simultaneously with the first and/or second contacts, forming a free-standing membrane defined by a polymeric gel (such as formed from the third precursor liquid). The third precursor liquid may be the same as or different from the first precursor liquid and/or the second precursor liquid. The first, second, and third precursor liquids include a non-volatile gel and a non-lithium salt, such as detailed above in the context of FIG. 1B.

In each instance, the method includes substantially aligning and/or stacking the first or negative electrolyte layer, the second or positive electrolyte layer, and the gel-assisted electrolyte layer and/or free-standing membrane defined by the polymeric gel. Although the above discussion describes a single negative electrode, a single positive electrode, and a single electrolyte layer, the skilled artisan will recognize that the current teachings apply to various other configurations, including those having one or more anodes, one or more cathodes, and one or more electrolyte layers, as well as various current collectors and current collector films with electroactive particle layers disposed on or adjacent to or embedded within one or more surfaces thereof.

In other variations, the present disclosure contemplates a method of making a first electrode, where the method generally includes an in situ process that includes contacting a polymeric precursor and a battery having an interparticle porosity (for example, the battery 20 illustrated in FIG. 1A). The contacting may include adding one or more drops of the polymeric precursor to the battery. The method further includes drying or reacting (e.g., cross-linking) the polymeric precursor to form a polymeric gel electrolyte system, like the polymeric gel electrolyte system 100 illustrated in FIG. 1B. In certain variations, the method may include preparing the polymeric precursor. Preparing the polymeric precursor may include contacting a non-volatile gel and a non-lithium salt, such as detailed above in the context of FIG. 1B.

Certain features of the current technology are further illustrated in the following non-limiting examples.

### Example 1

Example battery cells may be prepared in accordance with various aspects of the present disclosure. For example, the example battery cells may a polymeric gel electrolyte system including a non-volatile gel and a non-lithium salt. A first example battery cell 310 may include a first polymeric gel electrolyte system 312. The first polymeric gel electrolyte system 312 may include about 1 wt. % of magnesium bis(trifluoromethanesulfonyl)imide (Mg(TFSI)₂) as the non-lithium salt. A second example battery cell 320 may include a second polymeric gel electrolyte system 322. The second polymeric gel electrolyte system 322 may include about 1 wt. % of calcium bis(trifluoromethanesulfonyl)imide (Ca(TFSI)₂). The first and second polymeric gel electrolyte systems 312, 322 may each include poly(vinylidene fluoride-co-hexafluoropropylene (PVDF-HFP) as the polymeric host and a liquid electrolyte including 0.4 M lithium bis(trifluoromethanesulfonyl)imide (LiTFSI) and 0.4 M lithium tetrafluoroborate (LiBF₄) in a solvent mixture. The solvent mixture (e.g., 4:6 v/v) may include ethylene carbonate (EC) and gamma-butyrolactone (GBL).

Like battery 20 illustrated in FIGS. 1A and 1B, the first and second example battery cells 310, 320 include a first or negative electrode including a plurality of negative solid-state electroactive material particles, and optionally, a first plurality of solid-state electrolyte particles, disposed on or adjacent to a first surface of a first bipolar current collector. The example battery cells 310, 320 may further include a second or positive electrode parallel with the negative electrode. The positive electrode may include a plurality of positive solid-state electroactive material particles, and optionally, a second plurality of solid-state electrolyte particles, disposed on or adjacent to a first surface of a second bipolar current collector. The example battery cells 310, 320 may further include a solid-electrolyte layer disposed between and physically separating the negative electrode and the positive electrode. More specifically, the solid-electrolyte layer may separate the plurality of negative solid-state electroactive material particles (and the optional first plurality of solid-state electrolyte particles) and the plurality of positive solid-state electroactive material particles (and the optional second plurality of solid-state electrolyte particles). The negative electrodes and/or positive electrodes and/or solid-electrolyte layer may include polymeric gel electrolyte systems 312, 322, in accordance with various aspects of the present disclosure.

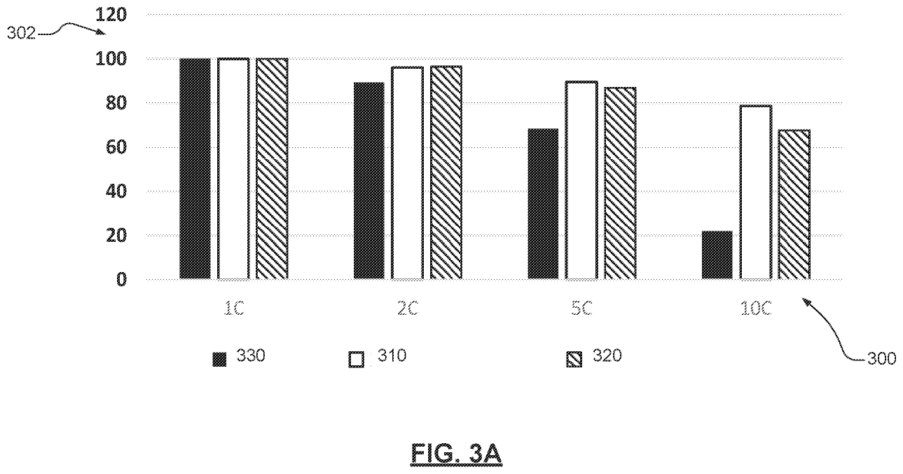

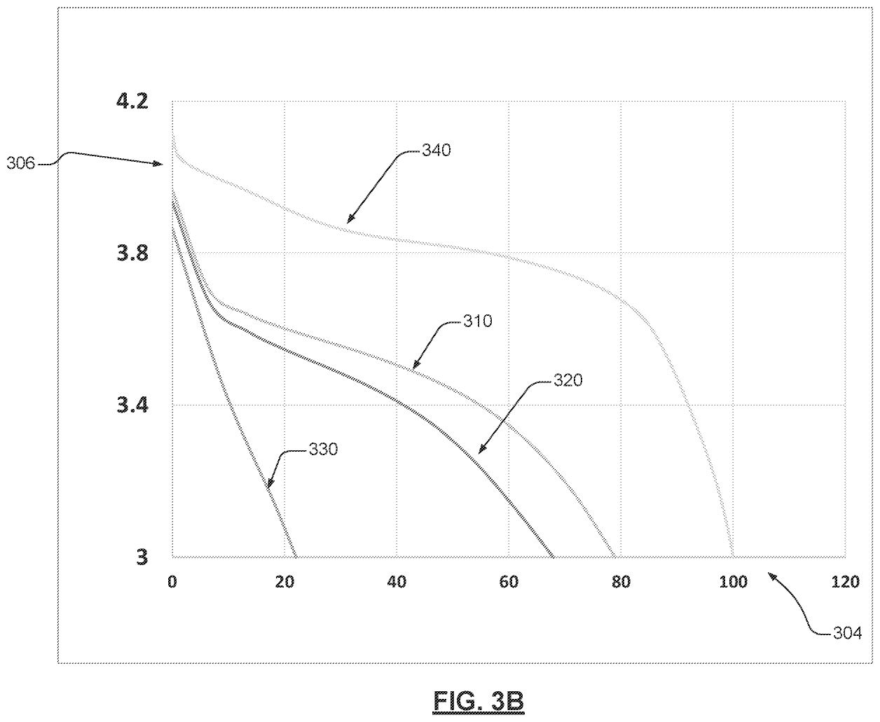

FIG. 3A is a graphical illustration demonstrating rate capability of the example battery cells 310, 320 including polymeric gel electrolyte systems 312, 322 in accordance with various aspects of the present disclosure and comparable battery cell 330 having the same configuration as the example battery cells 310, 320, but not including a polymeric gel electrolyte system. The x-axis 300 represents discharge rate (e.g., c-rate). C-rate is a measure of the rate at which a battery is discharged relative to its maximum capacity. For example, a 1 C rate indicates that the discharge current will discharge the entire battery for 1 hour. The y-axis 302 represents capacity retention (%). As illustrated, the example battery cells 310, 320 has improved long-term and high-power performance.

FIG. 3B is a graphical illustration demonstrating cell discharge of the example battery cells 310, 320 including polymeric gel electrolyte systems 312, 322 in accordance with various aspects of the present disclosure and comparable battery cell 330 having the same configuration as the example battery cells 310, 320, but not including a polymeric gel electrolyte system. The x-axis 304 represents capacity retention (%). The y-axis 306 represents voltage (V). Line 340 is the gel electrolyte discharge at 1 C rate. Line 310 is the discharge curve for example battery cell 310 at 10 C rate. Line 320 is the discharge curve for example battery 320 at 10 C rate. Line 330 is the discharge curve for the comparative battery 330 at 10 C rate. As illustrated, the example battery cells 310, 320 have improved high power performance as compared to the comparative battery 330, especially at 10 C rate.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A polymeric gel electrolyte for an electrochemical cell that cycles lithium ions, wherein the polymeric gel electrolyte comprises:
greater than or equal to about 0.1 wt. % to less than or equal to about 10 wt. % of a non-lithium salt.

2. The polymeric gel electrolyte of claim 1, wherein the non-lithium salt comprises:
a non-lithium cation having an ion radius that is greater than or equal to about 80% to less than or equal to about 250% of an ion radius of a lithium ion.

3. The polymeric gel electrolyte of claim 2, wherein the non-lithium cation is selected from the group consisting of: sodium (Na⁺), calcium (Ca²⁺), magnesium (Mg²⁺), potassium (K⁺), aluminum (Al³⁺), iron (Fe²⁺), manganese (Mn²⁺), strontium (Sr²⁺), zinc (Zn²⁺), and combinations thereof.

4. The polymeric gel electrolyte of claim 1, wherein the non-lithium salt comprises:
an anion selected from the group consisting of: bis-trifluoromethanesulfonimide (TFSI⁻), bis(fluorosulfonyl)imide (FSI⁻), bis(pentafluoroethanesulfonyl)imide (BETI⁻), trifluoromethyl sulfonate (OTf⁻), tetrafluoroborate (BF⁴⁻), hexafluorophosphate(PF₆⁻), nitrate (NO₃⁻), chloride (Cl⁻), bromide (Br⁻), and combinations thereof.

5. The polymeric gel electrolyte of claim 1 wherein the non-lithium salt is selected from the group consisting of: magnesium bis(trifluoromethanesulfonyl)imide (Mg(TFSI)₂), calcium bis(trifluoromethanesulfonyl)imide (Ca(TFSI)₂), potassium bis(trifluoromethanesulfonyl)imide (KTFSI), sodium nitrate (NaNO₃), sodium hexafluorophosphate(NaPF₆), and combinations thereof.

6. The polymeric gel electrolyte of claim 1, wherein the polymeric gel electrolyte system further comprises:
greater than or equal to about 50 wt. % to less than or equal to about 99.9 wt. % of a non-volatile gel, wherein the non-volatile gel comprises a liquid electrolyte.

7. The polymeric gel electrolyte of claim 6, wherein the non-volatile gel further comprises a polymeric host,
wherein the non-volatile gel comprises greater than 0 wt. % to less than or equal to about 50 wt. % of the polymeric host and greater than or equal to about 5 wt. % to less than or equal to about 99.9 wt. % of the liquid electrolyte.

8. The polymeric gel electrolyte of claim 7, wherein the polymeric host is selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

9. The polymeric gel electrolyte of claim 6, wherein the liquid electrolyte comprises:
a lithium salt selected from the group consisting of: lithium bis(fluorosulfonyl)imide (LiFSI), lithium bis(trifluoromethanesulfonyl)imide (LiTFSI), lithium bis(pentafluoroethanesulfonyl)imide (LiBETI), lithium hexafluorophosphate (LiPF₆), lithium tetrafluoroborate (LiBF₄), lithium trifluoromethyl sulfonate (LiTFO), lithium difluoro(oxalato)borate (LiDFOB), and combinations thereof; and
a solvent selected from the group consisting of: ethylene carbonate (EC), propylene carbonate (PC), gamma-butyrolactone (GBL), tetraethyl phosphate (TEP), fluoroethylene carbonate (FEC), and combinations thereof.

10. The polymeric gel electrolyte of claim 6, wherein the non-volatile gel further comprises:
greater than 0 wt. % to less than or equal to about 10 wt. % of an additive, wherein the additive is selected from the group consisting of: vinylene carbonate (VC), fluoroethylene carbonate (FEC), vinylethylene carbonate (VEC), butylene carbonate (BC), ethylene sulfite (ES), propylene sulfite (PS), and combinations thereof.

11. An electrochemical cell that cycles lithium ions, the electrochemical cell comprising:
a first electrode comprising a first solid-state electroactive material;
a second electrode comprising a second solid-state electroactive material; and
an electrolyte layer disposed between the first electrode and the second electrode, wherein at least one of the first electrode, the second electrode, and the electrolyte layer comprises a polymeric gel electrolyte system comprising greater than or equal to about 0.1 wt. % to less than or equal to about 10 wt. % of a non-lithium salt.

12. The electrochemical cell of claim 11, wherein the electrolyte layer comprises:
a plurality of solid-state electrolyte particles and the polymeric gel electrolyte system at least partially fills void spaces between the solid-state electrolyte particles.

13. The electrochemical cell of claim 11, wherein the electrolyte layer comprises:
a free-standing membrane having a thickness greater than or equal to about 5 μm to less than or equal to about 1,000 μm defined by the polymeric gel electrolyte system.

14. The electrochemical cell of claim 11, wherein the second solid-state electroactive material is a two-dimensional electroactive material.

15. The electrochemical cell of claim 11, wherein the polymeric gel electrolyte system comprises:
a first polymeric gel electrolyte at least partially filling void spaces in the first solid-state electroactive material; and
a second polymeric gel electrolyte at least partially filling void spaces in the second solid-state electroactive material.

16. The electrochemical cell of claim 11, wherein the non-lithium salt comprises:
a non-lithium cation having an ion radius that is greater than or equal to about 80% to less than or equal to about 250% of an ion radius of a lithium ion.

17. The electrochemical cell of claim 16, wherein the non-lithium cation is selected from the group consisting of: sodium (Na⁺), calcium (Ca²⁺), magnesium (Mg²⁺), potassium (K⁺), aluminum (Al³⁺), iron (Fe²⁺), manganese (Mn²⁺), strontium (Sr²⁺), zinc (Zn²⁺), and combinations thereof.

18. The electrochemical cell of claim 11, wherein the polymeric gel electrolyte system further comprises:
greater than or equal to about 50 wt. % to less than or equal to about 99.9 wt. % of a non-volatile gel, wherein the non-volatile gel comprises greater than or equal to 0 wt. % to less than or equal to about 50 wt. % of a polymeric host and greater than or equal to about 5 wt. % to less than or equal to about 100 wt. % of a liquid electrolyte.

19. The electrochemical cell of claim 18, wherein the non-volatile gel further comprises:
greater than 0 wt. % to less than or equal to about 10 wt. % of an additive selected from the group consisting of: vinylene carbonate (VC), fluoroethylene carbonate (FEC), vinylethylene carbonate (VEC), butylene carbonate (BC), ethylene sulfite (ES), propylene sulfite (PS), and combinations thereof.

20. An electrochemical cell that cycles lithium ions, the electrochemical cell comprising:
a first electrode comprising a first solid-state electroactive material;
a second electrode comprising a second solid-state electroactive material; and
an electrolyte layer disposed between the first electrode and the second electrode, wherein at least one of the first electrode, the second electrode, and the electrolyte layer comprises a polymeric gel electrolyte system, wherein the polymeric gel electrolyte system comprises:
greater than or equal to about 0.1 wt. % to less than or equal to about 10 wt. % of a non-lithium salt comprising a non-lithium cation selected from the group consisting of: sodium (Na⁺), calcium (Ca²⁺), magnesium (Mg²⁺), potassium (K⁺), aluminum (Al³⁺), iron (Fe²⁺), manganese (Mn²⁺), strontium (Sr²⁺), zinc (Zn²⁺), and combinations thereof; and
greater than or equal to about 50 wt. % to less than or equal to about 99.9 wt. % of a non-volatile gel, wherein the non-volatile gel comprises greater than or equal to 0 wt. % to less than or equal to about 50 wt. % of a polymeric host and greater than or equal to about 5 wt. % to less than or equal to about 100 wt. % of a liquid electrolyte.
